(19) United States
(12) Patent Application Publication
(10) Pub. No.: US 2019/0129380 A1
(43) Pub. Date: May 2, 2019

(54) MACHINE USAGE SYSTEM AND METHODS

(71) Applicant: DOZR INC, Kitchener (CA)

(72) Inventors: Kevin FORESTELL, GUELPH (CA); Dave CHALMERS, Waterloo (CA)

(21) Appl. No.: 16/176,126

(22) Filed: Oct. 31, 2018

Related U.S. Application Data
(60) Provisional application No. 62/579,468, filed on Oct. 31, 2017.

(51) Int. Cl. G05B 19/4063; G05B 19/401

(52) U.S. Cl. CPC G05B 19/4063; G05B 2219/33303; G05B 19/401

(57) ABSTRACT

Example machine usage systems and methods are disclosed. An example system for increasing usage of a machine includes a usage predictor to automatically identify a down period of the machine at a primary location; a usage allocator to automatically assign the machine to a supplemental use during the down period; a cost adjustor to adjust a cost of the machine using the usage value; a transport vehicle to transport the machine from the primary location to the supplemental location; and a transport planner to automatically trigger a transport of the machine to the supplemental location for the supplemental use. The transport planner includes a positioning device to estimate a transportation time between the primary location to the supplemental location and to determine a departure time, and a transport triggering system to trigger an operation of the transport vehicle to transport the machine to the supplemental location at the departure time.

### FIELD

The described embodiments relate to machine usage systems and methods. In particular, example methods and systems for increasing usage of a machine are described.

### BACKGROUND

Many machines are used for a short period each year and are idle in the other months of the year. For example, heavy-duty machines for farming and snow removal are used only for several months of a year and are then unnecessary for the other months. Due to the high cost associated with purchasing these machines and the typical short use each year, many consumers opt for alternatives to purchasing the machines, such as short term leases.

### SUMMARY

The various embodiments described herein generally relate to machine usage systems and methods. Example embodiments disclose methods and systems for increasing the usage of the machines.

In an embodiment, there is provided a system for increasing usage of a machine. The system includes a usage predictor to automatically identify a down period of the machine at a primary location, wherein the usage predictor: receives a machine type and an intended use of the machine at the primary location; and estimates the down period of the machine based on the machine type, the intended use of the machine, and at least one of forecast data and historical usage data; a usage allocator to automatically assign the machine to a supplemental use during the down period, wherein the supplemental use occurs at a supplemental location and the usage allocator: receives one or more requests to use the machine during at least one portion of the down period; and defines a usage value for the supplemental use of the machine during the at least one portion of the down period; a cost adjustor to adjust a cost of the machine using the usage value; a transport vehicle to transport the machine from the primary location to the supplemental location; and a transport planner to automatically trigger a transport of the machine to the supplemental location for the supplemental use, wherein the transport planner comprises: a positioning device to estimate a transportation time between the primary location to the supplemental location and to determine a departure time for the transport vehicle in order for the machine to arrive prior to the at least one portion of the down period; and a transport triggering system to trigger an operation of the transport vehicle to transport the machine to the supplemental location for the supplemental use at the departure time.

The machine may include a piece of equipment.

The primary location may include a geographical region.

The forecast data may include weather forecast data for the primary location.

The forecast data may include agriculture forecast data for the primary location.

The historical data may include related usage data, and the related usage data is associated with a use of at least one other machine within a proximity of the primary location and a machine type of the at least one other machine is the same as the machine type of the machine.

The historical data may include prior usage data of the machine.

The down period may include a consecutive time period.

The down period may include one or more discontinuous time periods.

The down period may include one or more months in a calendar year.

For a guarantee period, the usage allocator may automatically assign one or more supplemental uses for the down period.

The usage allocator may automatically: assign an initial portion of the down period to an initial supplemental use of the machine; and assign a subsequent portion of the down period to a subsequent supplemental use of the machine, wherein the initial portion and the subsequent portion are different time periods.

The initial supplemental use of the machine may be different from the subsequent supplemental use of the machine.

In a further aspect, there is provided a method for increasing usage of a machine. The method includes automatically identifying a down period of a machine, wherein automatically identifying the down period comprises: receiving a machine type and an intended use of the machine at a primary location; estimating the down period of the machine based on the machine type, the intended use of the machine, and at least one of forecast data and historical data; automatically assign the machine to a supplemental use during the down period, wherein the supplemental use occurs at a supplemental location and the assigning the machine to the supplemental use during the down period comprises: receiving one or more requests to use the machine during at least one portion of the down period; and defining a usage value for the supplemental use of the machine during the at least one portion of the down period; adjust a cost of the machine using the usage value; automatically trigger a transport of the machine to the supplemental location for the supplemental use, wherein triggering the transport of the machine comprises: operating a positioning device to estimate a transportation time between the primary location to the supplemental location and to determine a departure time for a transport vehicle transporting the machine in order for the machine to arrive prior to the at least one portion of the down period; and operating a transport triggering system to trigger an operation of the transport vehicle to transport the machine to the supplemental location for the supplement use at the departure time; and transporting the machine from the primary location to the supplemental location at the departure time.

In a further aspect, there is provided a method for increasing usage of a machine. The method includes automatically identifying a down period for a machine at a primary location; automatically assigning the machine to a supplemental use during the down period, wherein the supplemental use occurs at a supplemental location and the assigning the machine to the supplemental use during the down period comprises: receiving one or more requests to use the machine during at least one portion of the down period; and defining a usage value for the supplemental use of the machine during the at least one portion of the down period; displaying, to a potential buyer of the machine, a cost of the machine modified by the usage value compared to an unmodified cost of the machine.

Automatically identifying the down period may include receiving a machine type and an intended use of the machine at the primary location; estimating the down period of the machine based on the machine type, the intended use of the machine, and at least one of forecast data and historical data.

The down period may include a consecutive time period.

The down period may include one or more discontinuous time periods.

The down period may include one or more months in a calendar year.

The method may include, for a guarantee period, automatically assigning one or more supplemental uses for the down period.

Assigning the machine to the supplemental use during the down period may include assigning an initial portion of the down period to an initial supplemental use of the machine; and assigning a subsequent portion of the down period to a subsequent supplemental use of the machine, wherein the initial portion and the subsequent portion are different time periods.

### BRIEF DESCRIPTION OF THE DRAWINGS

Several embodiments will now be described in detail with reference to the drawings, in which:

FIG. 1A is a diagram of an example use of a machine in accordance with an example embodiment;

FIG. 1B is a diagram of an example supplemental use of the machine of FIG. 1A in accordance with an example embodiment;

FIG. 2 is a block diagram of an example system for increasing usage of a machine in accordance with an example embodiment;

FIG. 3 is a flowchart of an example method for increasing usage of a machine in accordance with an example embodiment;

FIG. 4 is an example user interface for requesting a machine in accordance with an example embodiment; and

FIG. 5 is a screenshot of an example machine auction interface in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Many machines, and in particular heavy-duty machines, are often used for several months in a calendar year, and are idle for the other months of the year. Some machines have seasonal uses, such as machines for farming and snow removal, and thus, are essential for a certain period each year but are unnecessary for the other periods of the year. The high costs associated with purchasing these machines and the typical short use each year often discourage many consumers from purchasing these machines. As a result, sales of these machines can be difficult.

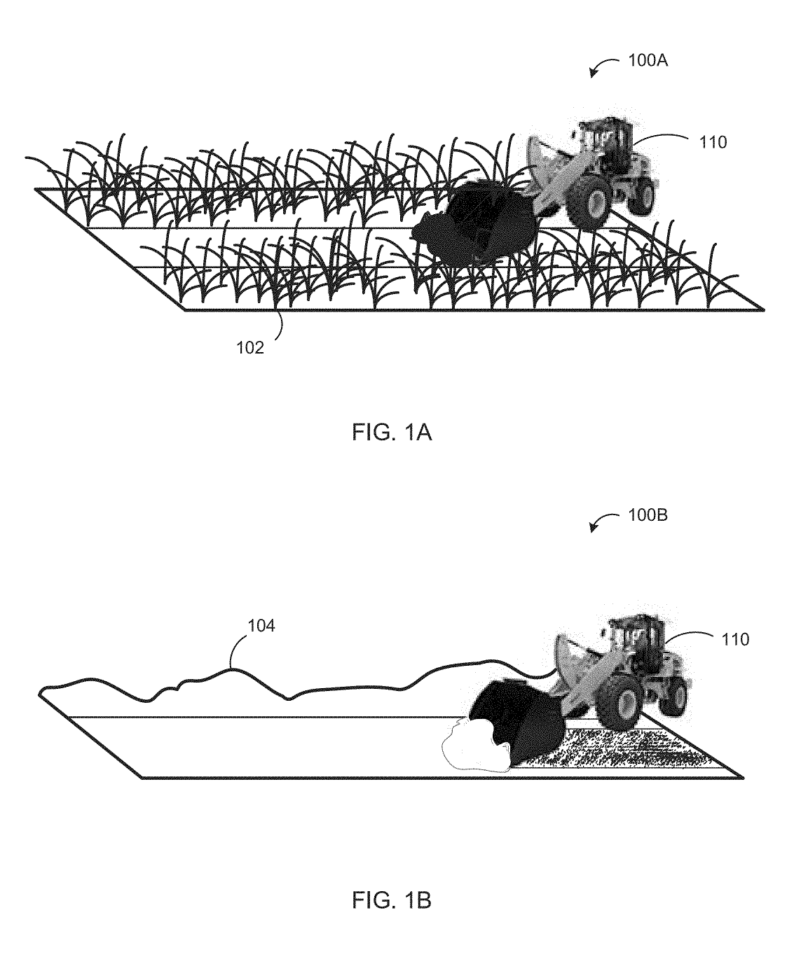

To increase usage of these machines, the systems and methods described herein automatically identify down periods of a machine and automatically assign supplemental uses of the machine during the down period. Typically, machines are versatile and can be used for different purposes. For example, FIG. 1A is a diagram 100A showing an example use of a machine 110 at a primary location 102, and FIG. 1B is a diagram 100B showing the same machine 110 at a supplemental location 104. The machine 110 is used for farming in FIGS. 1A and 1s used for snow removal in FIG. 1B.

In the example shown in FIGS. 1A and 1B, farming is the intended use of the machine 110 at the primary location 102. Based on various factors, such as the machine type of the machine 110, the intended use, and forecast data or historical usage data, the described system can determine a down period for the machine 110. The down period of the machine 110 includes the time periods in which the machine 110 will not be used for the intended use at the primary location 102. The down period can include one or more months of a calendar year, and can include a consecutive time period or discontinuous time periods.

The described system can determine that the machine 110 will have a down period during the winter months. Since farming and snow removal typically takes place at different time periods of a year, the described system can assign the machine 110 to snow removal during the winter months (i.e., when the machine 110 would typically be idle as no farming activity takes place in the winter months). By automatically assigning the down period of the machine 110 to one or more supplemental uses, the owner of the machine 110 can receive additional revenue from the supplemental use(s) instead of leaving the machine 110 idle during the down period.

It is possible for the primary location 102 of the machine 110 to be at a different geographical region than the supplemental location 104. A geographical region can include a region within a city, a state or province, a country, or continent. A transport vehicle can be operated by the described system to transport the machine 110 from the primary location 102 to the supplemental location 104.

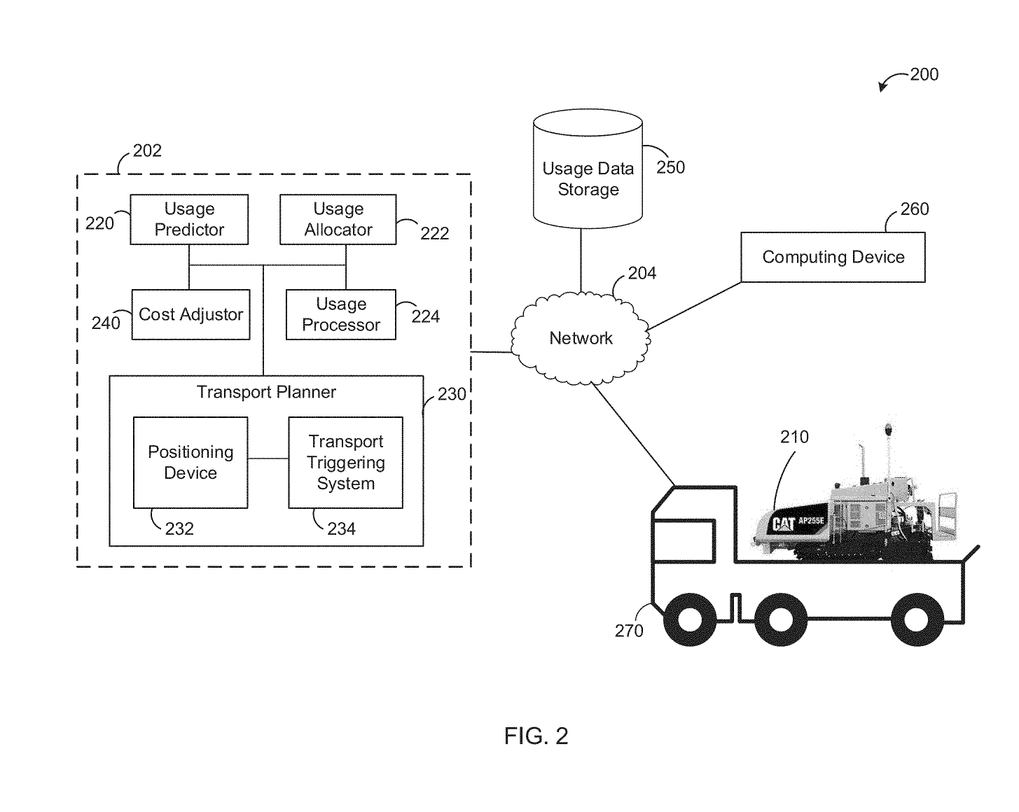

Reference is now made to FIG. 2, which illustrates a block diagram 200 of an example machine usage system 202 for increasing usage of the machine 210.

Although example machines 110, 210 are shown in FIGS. 1A, 1B and 2, it will be understood that the machines 110, 210 can include, but are not limited to, excavators, mini excavators, tractors, wheel loaders, track loaders, skid steers, skid loaders, rock trucks, dozers, backhoes, compaction, graders, forklifts, platforms, surface work machines, cranes, aggregate and topsoil machines, site dumpers, vehicles (e.g., vans and trucks). In some embodiments, the machines 110, 210 can include a piece of equipment, such as signage, foundation equipment, attachments for the machines 110, 210, containers or storage.

The machine usage system 202 includes a usage predictor 220, a usage allocator 222, a usage processor 224, a cost adjustor 240, and a transport planner 230. The transport planner 230 can include a positioning device 232 and a transport triggering system 234.

In some embodiments, the usage predictor 220, the usage allocator 222, the usage processor 224, the cost adjustor 240, and the transport planner 230 may be combined or may be separated into further components that may be distributed over a wide geographic area and connected via a network 204. The usage predictor 220, the usage allocator 222, the cost adjustor 240, and the transport planner 230 can be implemented using software, hardware, or a combination of software and hardware, such as application specific circuitry or some other suitable technique.

Although not shown in FIG. 2, the machine usage system 202 can include an interface component for facilitating communication between the machine usage system 202 and a network 204. For example, the interface component can include one or more of a serial port, a parallel port or a USB port, and/or one or more of an Internet, Local Area Network (LAN), Ethernet, Firewire, modem or digital subscriber line connection. The interface component can also receive input from various input devices, such as a mouse, a keyboard, a touch screen, a thumbwheel, a track-pad, a track-ball, a card-reader, voice recognition software and the like depending on the requirements and implementation of the machine usage system 202.

The usage processor 224 controls the operation of the machine usage system 202. The usage processor 224 may be any suitable processors, controllers or digital signal processors that can provide sufficient processing power depending on the configuration, purposes and requirements of the machine usage system 202. For example, the usage processor 224 can trigger the operation of the usage predictor 220, the usage allocator 222, the cost adjustor 240, the transport planner 230, and/or a transport vehicle 270. In some embodiments, the usage processor 224 can include more than one processor with each processor being configured to perform different tasks.

The usage predictor 220 can be operated by the usage processor 224 to automatically identify the down period for the machine 210. The usage predictor 220 can receive a machine type and an intended use from an operator of the machine 210 via the network 204 and/or via an interface component (not shown) of the machine usage system 202. The operator of the machine 210 can include the user of the machine 210, the owner of the machine 210 and/or an individual responsible for the machine 210. Based on at least the received machine data and usage data, the usage predictor 220 can estimate the down period for the machine 210.

The usage allocator 222 can be operated by the usage processor 224 to automatically assign the machine 210 to a supplemental use during the down period. The supplemental use, as described with reference to FIGS. 1A and 1B, can occur at a supplemental location 104 that is different from the primary location 102. The usage allocator 222 can also determine a usage value for the supplemental use of the machine 210 during the at least one portion of the down period.

The cost adjustor 240 adjusts a cost of the machine 210 with the usage value determined by the usage allocator 222. The cost adjustor 240 can, in some embodiments, display the adjusted cost of the machine 210 to a potential purchaser via the interface component and/or an interface accessible via a computing device 260.

Although the transport planner 230 is shown in FIG. 2 to be remote from the transport vehicle 270, part of the transport planner 230 can be located at the transport vehicle 270 and/or the machine 210 being transported.

The positioning device 232 can include a positioning receiver mounted on the machine 210 for determining the location of the machine 210 and a navigation component at the machine 210, the transport vehicle 270 and/or the machine usage system 202. For example, the positioning receiver can include a receiver operable to receive satellite signals for autonomous geo-spatial positioning. Based on the detected position of the machine 210, the navigation component of the positioning device 232 can then calculate the departure time of the transport vehicle 270 from the primary location 102 or from a location of the transport vehicle 270 if that location is different from the primary location 102. The positioning device 232 can calculate the departure time to take into account the transport vehicle 270's commute to the primary location 102.

The transport triggering system 234 triggers the transport vehicle 270 to transport the machine 210 to the supplemental location 104 at the departure time calculated by the positioning device 232. In some embodiments, the transport triggering system 234 can transmit alerts to a user interface located at the transport vehicle 270 and/or a computing device 260 of an operator of the transport vehicle 270 to indicate that the transport vehicle 270 needs to begin the transportation of the machine 210 at an upcoming departure time in order to arrive in time for the supplemental use during the assigned portion of the down period.

In some embodiments, the positioning device 232 determines the location of the machine 210 based on data received from the operator of the machine 210, such as the address of the operator and/or the primary location of the machine 210.

The machine usage system 202 communicates with other components, such as a usage data storage 250, a computing device 260 and a transport vehicle 270 via the network 204.

The network 204 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the machine usage system 202, the usage data storage 250, the computing device 260 and the transport vehicle 270.

The usage data storage 250 can include RAM, ROM, one or more hard drives, one or more flash drives or some other suitable data storage elements such as disk drives, etc. The usage data storage 250 may further include one or more databases for storing information relating to, for example, historical usage by the operator of the machine 210 or related usage by other operators of similar or the same type of machine as machine 210.

Although only one computing device 260 is shown in FIG. 2, it will be understood that more than one computing device 260 can be in communication with the machine usage system 202 via the 204.

The computing device 260 can include any networked device operable to connect to the network 204 through a wired or wireless connection. The computing device 260 includes at least a processor and memory, and may be, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Although only one transport vehicle 270 is shown in FIG. 2, it will be understood that more than one transport vehicle 270 can be in communication with the machine usage system 202 and/or operable by the machine usage system 202 at any one time.

In some embodiments, the example machine usage system 202 includes the transport vehicle 270. The transport vehicle 270 can be an autonomous vehicle operable by the machine usage system 202 via the network 204.

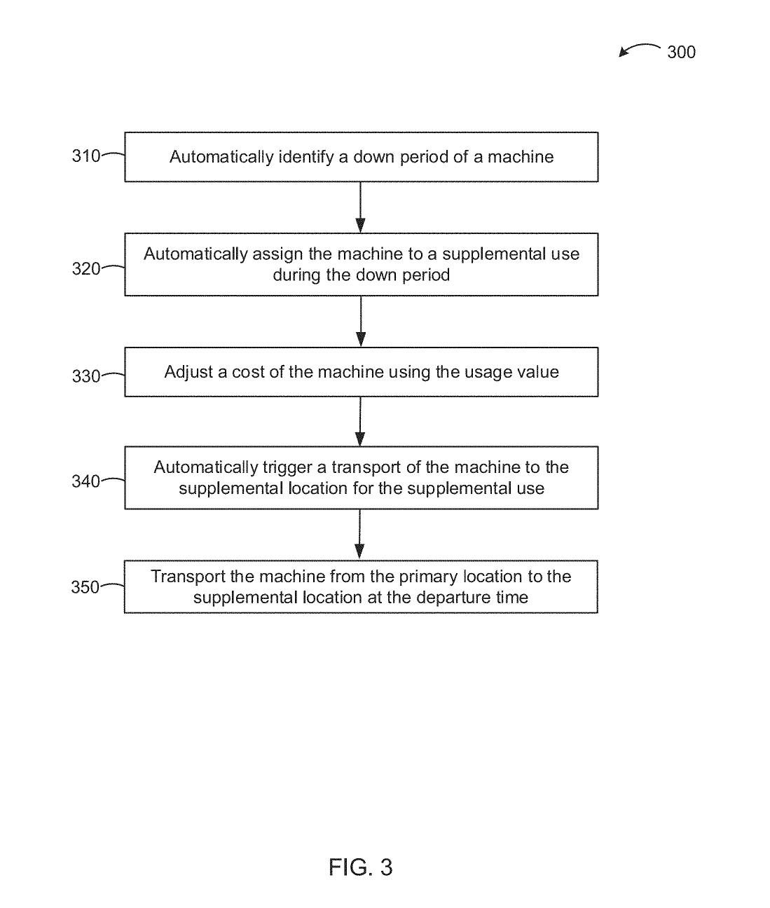

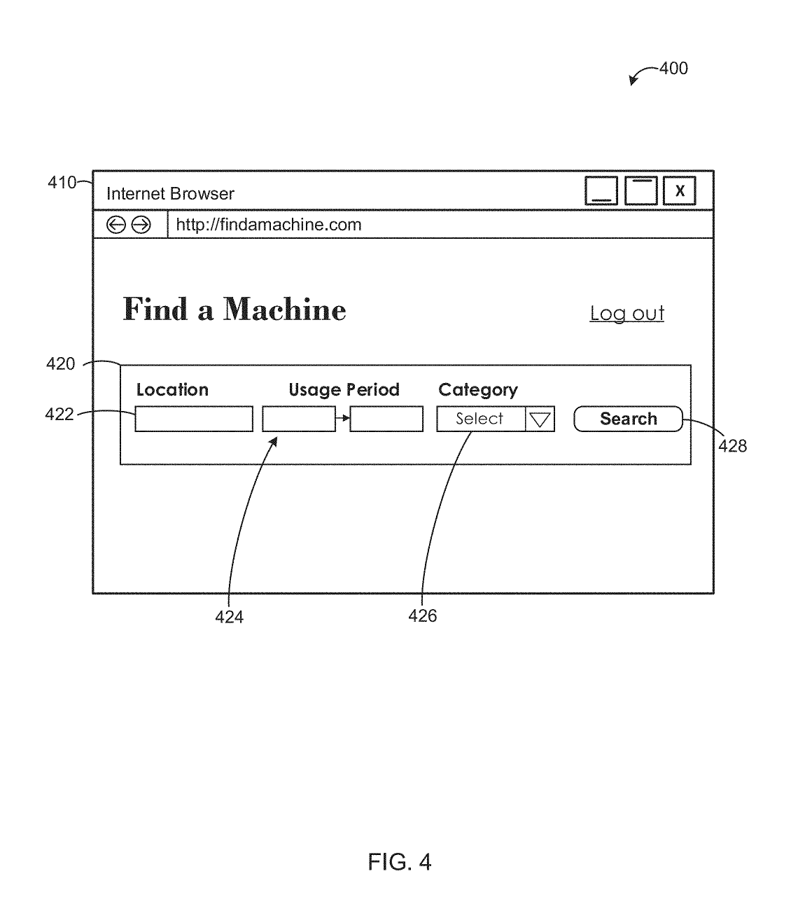

Referring now to FIG. 3, which is a flowchart of an example method 300 of increasing usage of a machine 110, 210. To illustrate the method 300, reference will be made to FIG. 4, which is an example user interface 400 for requesting the machine 110, 210.

At 310, the usage predictor 220 automatically identifies the down period of the machine 210.

The usage predictor 220 receives various data in respect of the machine 210 and the intended use of the machine 210 from the operator via the network 204 and/or the interface component of the machine usage system 202. The data received by the usage predictor 220 can include a machine type of the machine 210, the intended use of the machine, and the primary location 102 for the intended use. The usage predictor 220 can receive the primary location 102 from the operator of the machine 210, or can automatically determine the primary location 102 from the metadata embedded in the data in respect of the machine type and/or the intended use.

Depending on the intended use of the machine 210, the down period can vary each year due to various different factors, such as weather and/or local regulations. To determine the down period, the usage predictor 220 can retrieve forecast data relevant to the intended use, such as weather forecast and/or agricultural forecast for the primary location 102, from various data sources via the network 204.

The usage predictor 220 can also consider historical usage data of a machine that is of a similar type or the same type as the machine 210 by retrieving usage data from the usage data storage 250 available via the network 204. The historical usage data can include prior usage by the operator of the machine 210 and/or related usage by other operators in proximity to the primary location 102. The historical usage data can include usage data of a machine of the same type or a machine with similar functionality as the machine 210.

For example, in respect of FIG. 1A, the usage predictor 220 receives the machine type of the machine 110 and the intended use (i.e., farming) at the primary location 102 from the operator of the machine 110. The primary location 102 can include a larger geographical region, such as Western Canada, or a smaller geographical region, such as a city (e.g., Calgary, Alberta). Using the weather forecast data and the agricultural forecast data available via the network 204, and the related usage data stored in the usage data storage 250 of similar machines within Calgary, Alberta, the usage predictor 220 can determine a down period of the machine 110 in 2018 for farming in Calgary, Alberta to be between January to April and October to December.

At 320, the usage allocator 222 automatically assigns the machine 210 to a supplemental use during the down period.

To identify the supplemental use(s), the usage allocator 222 can receive requests to use the machine 210 for a portion, or entirety, of the down period via the network 204. The portion of the down period requested can be continuous or discontinuous time periods. In some embodiments, different machines 210 may be assigned to the supplemental use in order to fulfil the period requested. The request can be received via an interface component (not shown) of the machine usage system 202 or via the network 204 from the computing device 260 operated by an individual making the request.

FIG. 4 shows an example user interface 400 for receiving a request for a machine 110, 210. In this example, the user interface 400 is provided via an internet browser 410. In other embodiment, the user interface 400 can be provided via an application installed at the computing device 260, for example.

The user interface 400 includes a request component 420 that includes several input data fields and controls, such as a location data field 422, a usage period data field 424, a machine category dropdown data field 426 and a submission control 428. The machine category dropdown data field 426 can include a list of the various machines available to be used. Once the data fields 422, 424 and 426 are filled and the submission control 428 is activated, the usage allocator 222 receives the request data. The usage allocator 222 can then evaluate the request data to identify the machines 110, 210 with a down period that can fulfill the request.

The usage allocator 222 can assign an initial portion of the down period to an initial supplemental use of the machine 210, and assign a subsequent portion of the down period to a subsequent supplemental use of the machine 210. The initial portion and the subsequent portion are different time periods. The initial supplemental use of the machine 210 can be different from the subsequent supplemental use of the machine 210.

Continuing with the example shown in FIGS. 1A and 1B, a request can be received via the user interface 400 for a machine of the same machine type as the machine 110 and for the usage period, January to February and November to December of 2018. The usage allocator 222 can then assign the requested use to a portion of the down period identified by the usage predictor 220. The down period of the machine 110, March to April and October 2018, remain unused. The usage allocator 222 can continue to assign the machine 210 to subsequent supplemental uses for March to April and October 2018.

The usage allocator 222 can then define a usage value for the supplemental use of the machine 110 for January to February and November to December of 2018. The usage value corresponds to a monetary amount that is earned by the operator of the machine 110 for making the machine 110 available for the supplemental use.

In some embodiments, the usage allocator 222 automatically assigns supplemental use(s) for the entire down period of the machine 210 for a guarantee period. As the high cost of many machines 110, 210 and the limited usage periods each year can discourage many consumers from purchasing the machines 110, 210, the machine usage system 202 can operate to ensure supplemental uses for the entire down period of the machine 210 for the guarantee period. The guarantee period is a time period in which the machine usage system 202 can ensure the down period of the machine 210 is assigned supplemental uses.

By ensuring the supplemental uses for the down period of the machine 210 for the guarantee period, the machine usage system 202 can provide an offset to the purchase price, which can make purchasing more appealing to some consumers. For example, a guarantee period for the machine 110 of FIGS. 1A and 1B can be 4 years and since the down period for the machine 110 is estimated to be 6 months in a year (e.g., January to March and October to December), the machine usage system 202 can provide a guaranteed supplemental use for 6 months each year for a 4 year period from the purchase of the machine 110. In the case that the machine 110 costs $100,000 to purchase and the usage value of each month of supplemental use is $3000, the modified cost of the machine 110 is $28,000.

At 330, the cost adjustor 240 adjusts a cost of the machine 210 using the usage value.

The cost adjustor 240 can illustrate how the usage value can offset the purchase price of the machine 210. Although the usage value will not reduce the upfront purchase price of the machine 210, the usage value can show the consumer the overall value of the machine 210 after purchase. To illustrate the offset of the purchase price that the guaranteed supplemental uses can offer, the usage allocator 222 can define the usage value for the supplemental uses during the guarantee period and the cost adjustor 240 can display a comparison of a cost of the machine 210 modified by the usage value to an unmodified cost of the machine 210. In the example of FIGS. 1A and 1B, the cost adjustor 240 can display a comparison of the unmodified cost of the machine 110 of $100,000 to a modified cost of $28,000. The comparison of the unmodified cost of the machine 110 to the modified cost may also be displayed in a per time period view (for example price per month).

At 340, the transport planner 230 automatically triggers a transport of the machine 210 to the supplemental location 104 for the supplemental use.

The transport planner 230 helps to ensure that the machine 210 arrives in time for the supplemental use. The transport planner 230 operates the positioning device 232 to estimate a transportation time from the primary location 102 to the supplemental location 104. The positioning device 232 also determines a departure time for the transport vehicle 270 in order for the machine 210 to arrive prior to the portion of the down period assigned to the supplemental use.

Continuing with the example shown in FIGS. 1A and 1B, the positioning device 232 can determine that the machine 110 is at the primary location 102 but the transport vehicle 270 is approximately 1 hour away from the primary location 102. The positioning device 232 determines that the transportation time between the primary location 102 and the supplemental location 104 will be approximately 5 hours. To ensure that the machine 110 arrives for the supplemental use during the assigned portion of the down period (e.g., Oct. 1, 2018), the positioning device 232 determines the departure time for the transport vehicle 270 to be approximately 10 am on Sep. 30, 2018 so that the machine 110 arrives before the start of business on October 1.

The transport planner 230 then operates the transport triggering system 234 to trigger an operation of the transport vehicle 270 to transport the machine 210 to the supplemental location 104 at the departure time. For the example shown in FIGS. 1A and 1B, the transport triggering system 234 can generate an alert to the computing device 260 of the operator of the transport vehicle 270 at approximately 9:30 to 10 am on Sep. 30, 2018 to initiate the transport of the machine 110.

At 350, the transport vehicle 270 transports the machine 210 from the primary location 102 to the supplemental location 104.

The transport vehicle 270 can depart at approximately the departure time determined by the transport planner 230. In the example of FIGS. 1A and 1B, the machine usage system 202 can trigger the transport vehicle 270 to begin transport at approximately 9:30 to 10 am on Sep. 30, 2018.

In some embodiments, an example method for increasing usage of the machines 110, 210 can include automatically identifying the down period for the machine 110, 210 at the primary location 102, automatically assigning the machine 110, 210 to the supplemental use during the down period, and displaying a comparison of a cost of the machine 110, 210 modified by the usage value to an unmodified cost of the machine 110, 210.

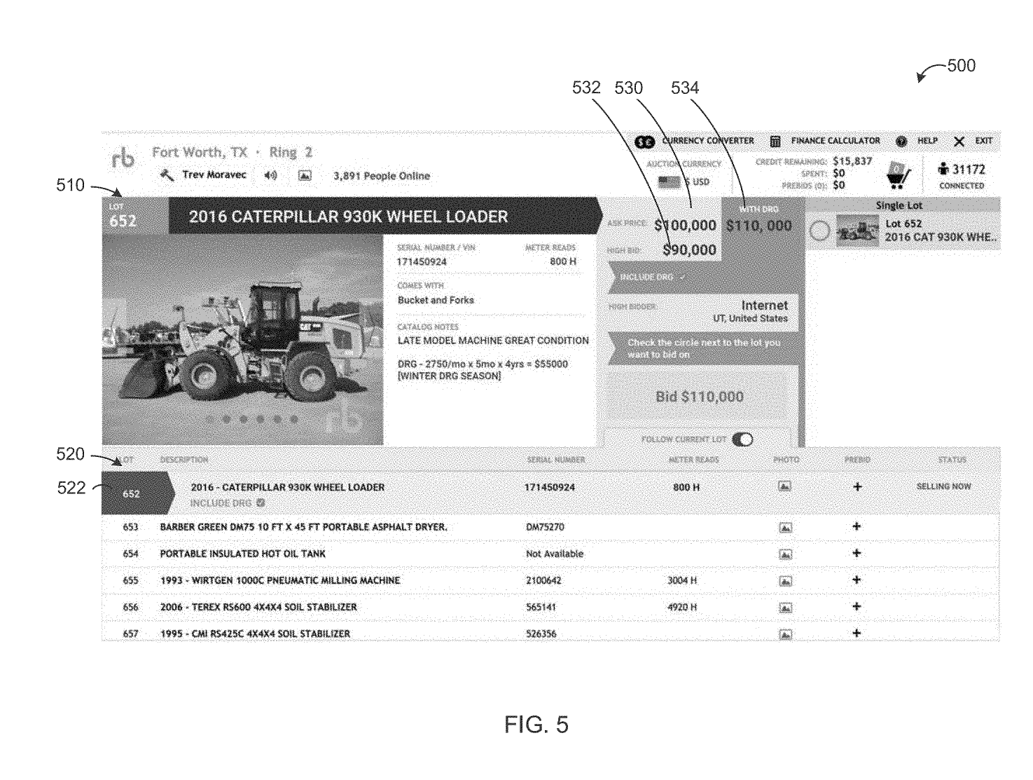

Referring now to FIG. 5, which is a screenshot of an example machine auction interface 500. On the machine auction interface 500 is a list 520 of items that can be auctioned, such as “Lot 652” (identified as item 522). The details of item 522 are shown generally at 510. As can be seen in the machine auction interface 500, the item 522 is a “2016 Caterpillar 930K Wheel Loader” with Ser. No. 17/450,924 and a meter reading of 800 H. The ask price 530 is set at USD $100,000 with a current bid of $90,000. The auction also offers the purchaser the opportunity to purchase a guaranteed supplemental use for a guarantee period of 4 years and a down period each year of 5 months. The bid price with the supplemental use guarantee 534 for item 522 is $110,000.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

We claim:

1. A system for increasing usage of a machine, the system comprising:
a usage predictor to automatically identify a down period of the machine at a primary location, wherein the usage predictor:
receives a machine type and an intended use of the machine at the primary location; and
estimates the down period of the machine based on the machine type, the intended use of the machine, and at least one of forecast data and historical usage data;
a usage allocator to automatically assign the machine to a supplemental use during the down period, wherein the supplemental use occurs at a supplemental location and the usage allocator:
receives one or more requests to use the machine during at least one portion of the down period; and
defines a usage value for the supplemental use of the machine during the at least one portion of the down period;
a cost adjustor to adjust a cost of the machine using the usage value;
a transport vehicle to transport the machine from the primary location to the supplemental location; and
a transport planner to automatically trigger a transport of the machine to the supplemental location for the supplemental use, wherein the transport planner comprises:
a positioning device to estimate a transportation time between the primary location to the supplemental location and to determine a departure time for the transport vehicle in order for the machine to arrive prior to the at least one portion of the down period; and
a transport triggering system to trigger an operation of the transport vehicle to transport the machine to the supplemental location for the supplemental use at the departure time.

2. The system of claim 1, wherein the forecast data comprises weather forecast data for the primary location.

3. The system of claim 1, wherein the forecast data comprises agriculture forecast data for the primary location.

4. The system of claim 1, wherein the historical data comprises related usage data, and the related usage data is associated with a use of at least one other machine within a proximity of the primary location and a machine type of the at least one other machine is the same as the machine type of the machine.

5. The system of claim 1, wherein the historical data comprises prior usage data of the machine.

6. The system of claim 1, wherein, for a guarantee period, the usage allocator automatically assigns one or more supplemental uses for the down period.

7. The system of claim 1, wherein the usage allocator automatically:
assigns an initial portion of the down period to an initial supplemental use of the machine; and
assigns a subsequent portion of the down period to a subsequent supplemental use of the machine, wherein the initial portion and the subsequent portion are different time periods.

8. A method for increasing usage of a machine, the method comprising:
automatically identifying a down period of a machine, wherein automatically identifying the down period comprises:
receiving a machine type and an intended use of the machine at a primary location;
estimating the down period of the machine based on the machine type, the intended use of the machine, and at least one of forecast data and historical data;
automatically assign the machine to a supplemental use during the down period, wherein the supplemental use occurs at a supplemental location and the assigning the machine to the supplemental use during the down period comprises:
receiving one or more requests to use the machine during at least one portion of the down period; and
defining a usage value for the supplemental use of the machine during the at least one portion of the down period;
adjust a cost of the machine using the usage value;
automatically trigger a transport of the machine to the supplemental location for the supplemental use, wherein triggering the transport of the machine comprises:
operating a positioning device to estimate a transportation time between the primary location to the supplemental location and to determine a departure time for a transport vehicle transporting the machine in order for the machine to arrive prior to the at least one portion of the down period; and
operating a transport triggering system to trigger an operation of the transport vehicle to transport the machine to the supplemental location for the supplement use at the departure time; and
transporting the machine from the primary location to the supplemental location at the departure time.

9. The method of claim 8, wherein the forecast data comprises weather forecast data for the primary location.

10. The method of claim 8, wherein the forecast data comprises agriculture forecast data for the primary location.

11. The method of claim 8, wherein the historical data comprises related usage data, and the related usage data is associated with a use of at least one other machine within a proximity of the primary location and a machine type of the at least one other machine is the same as the machine type of the machine.

12. The method of claim 8, wherein the historical data comprises prior usage data of the machine.

13. The method of claim 8 further comprising, for a guarantee period, automatically assigning one or more supplemental uses for the down period.

14. The method of claim 8, wherein assigning the machine to the supplemental use during the down period comprises:
assigning an initial portion of the down period to an initial supplemental use of the machine; and
assigning a subsequent portion of the down period to a subsequent supplemental use of the machine, wherein the initial portion and the subsequent portion are different time periods.

15. A method for increasing usage of a machine, the method comprising:
automatically identifying a down period for a machine at a primary location;
automatically assigning the machine to a supplemental use during the down period, wherein the supplemental use occurs at a supplemental location and the assigning the machine to the supplemental use during the down period comprises:
receiving one or more requests to use the machine during at least one portion of the down period; and
defining a usage value for the supplemental use of the machine during the at least one portion of the down period;
displaying, to a potential buyer of the machine, a cost of the machine modified by the usage value compared to an unmodified cost of the machine.

16. The method of claim 15, wherein automatically identifying the down period comprises:
receiving a machine type and an intended use of the machine at the primary location;
estimating the down period of the machine based on the machine type, the intended use of the machine, and at least one of forecast data and historical data

17. The method of claim 15, wherein the down period comprises a consecutive time period.

18. The method of claim 15, wherein the down period comprises one or more discontinuous time periods.

19. The method of claim 15 further comprising, for a guarantee period, automatically assigning one or more supplemental uses for the down period.

20. The method of claim 15, wherein assigning the machine to the supplemental use during the down period comprises:
assigning an initial portion of the down period to an initial supplemental use of the machine; and
assigning a subsequent portion of the down period to a subsequent supplemental use of the machine, wherein the initial portion and the subsequent portion are different time periods.
